(19) United States
(12) Patent Application Publication
(10) Pub. No.: US 2007/0279942 A1
(43) Pub. Date: Dec. 6, 2007

(54) Illuminating assembly having refractive member

(75) Inventor: Jung Chih Tsai, Tauyuan Hsien (TW)

Correspondence Address: CHARLES E. BAXLEY, ESQ., 90 JOHN STREET, THIRD FLOOR, NEW YORK, NY, 10038, US

(73) Assignee: Taiwan Nano Electro-Optical Technology Co., Ltd.

(21) Appl. No.: 11/444,199

(22) Filed: May 31, 2006

(51) Int. Cl. F21V 7/04; F21V 5/02

(52) U.S. Cl. 362/626; 362/620; 362/606; 362/330

(57) ABSTRACT

An illuminating assembly includes a light source, and a refracting member disposed beside the light source for refracting a light generated by the light source, the refracting member includes a bottom portion having a light refracting device or one or more bulges for refracting the light generated by the light source, and includes an upper portion having another light refracting device or one or more swellings for refracting the light refracted from the first light refracting device. The bulge and the swelling each include two surfaces for forming an included angle between the surfaces, the bulge is preferably perpendicular to the swelling.

### BACKGROUND OF THE INVENTION

1. Field of the Invention

The present invention relates to an illuminating assembly, and more particularly to an illuminating assembly having a refracting member for refracting and/or concentrating and/or diffusing and/or enhancing and/or reinforcing the light generated by a light source of the illuminating assembly.

2. Description of the Prior Art

Typical illuminating assemblies or light devices comprise a light source for generating and emitting a light to light various objects or to light the environment. In some of the typical illuminating assemblies or light devices, a light tube or light pipe or other light refractive members may further be provided and disposed beside or close to the light source for refracting or diffusing the light generated by the light source of the typical illuminating assemblies or light devices.

For example, U.S. Pat. No. 5,319,527 to Murphy et al. discloses one of the typical illuminating assemblies or light devices comprising a pointer including a pointer arm having a rear reflective surface for reflecting the light that is generated by a light source, and for reflecting the light toward or through an exit surface. However, the reflective surface of the pointer arm is a planar or inclined surface and may only be used for reflecting the light out through the exit surface of the pointer arm, but may not be used for refracting or diffusing the light.

U.S. Pat. No. 5,938,324 to Salmon et al. discloses another typical illuminating assembly or light device comprising a light pipe for transmitting a light from a printed circuit board through an opening in a panel, i.e., the light pipe may only be used for refracting the light but may not be used for concentrating and/or enhancing the light.

The present invention has arisen to mitigate and/or obviate the afore-described disadvantages of the conventional illuminating assemblies or light devices.

### SUMMARY OF THE INVENTION

The primary objective of the present invention is to provide an illuminating assembly including a refracting member for suitably refracting and/or concentrating and/or diffusing and/or enhancing and/or reinforcing the light generated by a light source of the illuminating assembly.

In accordance with one aspect of the invention, there is provided an illuminating assembly comprising a light source, and a refracting member disposed beside the light source for refracting a light generated by the light source, the refracting member includes a bottom portion having a first light refracting device provided on the bottom portion of the refracting member for refracting the light generated by the light source, and includes an upper portion having a second light refracting device provided on the upper portion of the refracting member for refracting the light from the first light refracting device.

The first light refracting device includes at least one bulge extended from the bottom portion of the refracting member for refracting the light generated by the light source. The refracting member includes a front portion facing toward the light source, the bulge includes two surfaces for forming an included angle between the surfaces, the bulge and the surfaces of the bulge are arranged parallel to the front portion of the refracting member.

A first surface of the surfaces of the bulge includes an extended plane located closer to the light source, and a second surface of the surfaces of the bulge includes an extended plane located farther away from the light source. The first surface of the bulge includes a width greater than that of the second surface of the bulge.

The refracting member includes a rear portion located distal to the light source, the front portion of the refracting member includes a thickness greater than that of the rear portion of the refracting member.

The second light refracting device includes at least one swelling extended from the upper portion of the refracting member for refracting the light from the bulge of the first light refracting device. The swelling of the second light refracting device is perpendicular to the bulge of the first light refracting device.

The first light refracting device includes a second bulge extended from the bottom portion of the refracting member for refracting the light generated by the light source. The bulge is located closer to the light source, and the second bulge is located farther away from the light source.

The second light refracting device includes at least one swelling extended from the upper portion of the refracting member for refracting the light from the bulge of the first light refracting device. The swelling of the second light refracting device includes two surfaces for forming an included angle between the surfaces.

The first light refracting device includes at least one bulge extended from the bottom portion of the refracting member, the swelling of the second light refracting device is perpendicular to the bulge of the first light refracting device.

A reflector may further be provided and disposed close to the light source for reflecting the light generated by the light source, a reflective member may further be provided and disposed below the refracting member for reflecting the light from the refracting member, and a diffusive member may further be provided and disposed above the refracting member for diffusing the light from the refracting member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a side plan schematic view of an illuminating assembly in accordance with the present invention;

FIG. 2 is an upper perspective view illustrating a refracting member for the illuminating assembly;

FIG. 3 is a partial upper perspective view of the illuminating assembly;

FIG. 4 is a partial plan schematic view illustrating a portion of the refracting member;

FIG. 5 is a partial bottom perspective view of the illuminating assembly;

FIG. 6 is a side plan schematic view similar to FIG. 1, illustrating the other arrangement of the illuminating assembly;

FIG. 7 is an upper perspective view illustrating a refracting member for the illuminating assembly as shown in FIG. 6;

FIG. 8 is a partial upper perspective view of the illuminating assembly as shown in FIGS. 6 and 7; and

FIG. 9 is a partial bottom perspective view of the illuminating assembly as shown in FIGS. 6-8.

### DETAILED DESCRIPTION OF THE PREFERRED EMBODIMENT

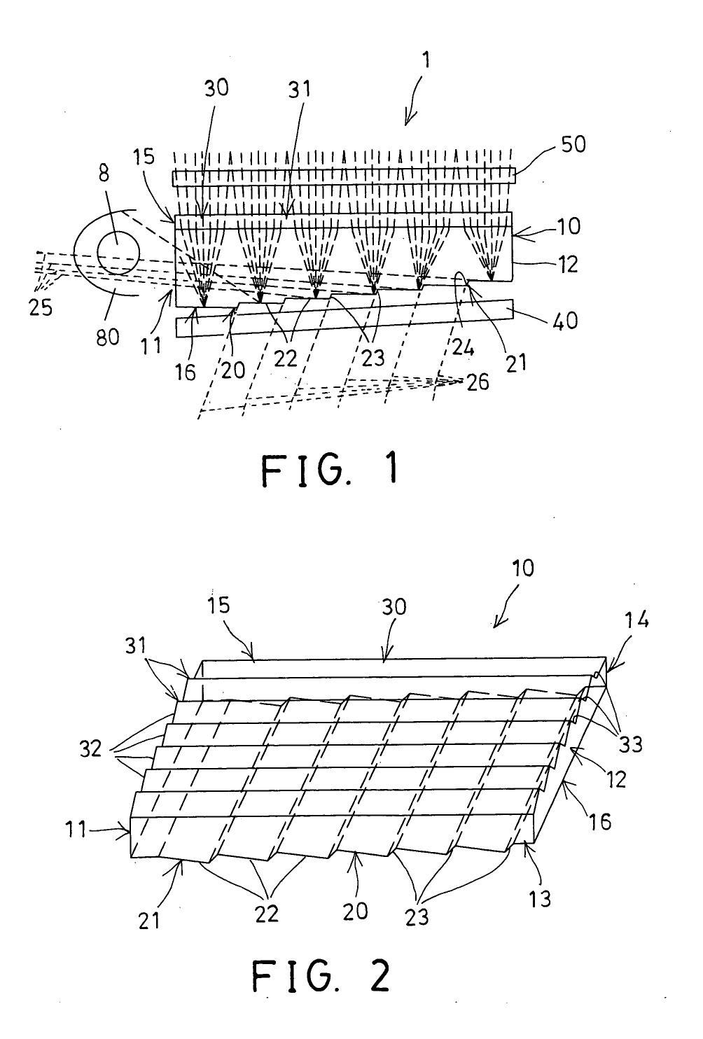

Referring to the drawings, and initially to FIGS. 1 and 2, an illuminating assembly 1 in accordance with the present invention comprises a refracting member 10 disposed beside a light source 8 for suitably refracting and/or concentrating and/or diffusing and/or enhancing and/or reinforcing a light generated by the light source 8, such as a light emitting diode, a light tube or light bulb, a light illuminant device or other light devices. A reflector 80 may optionally or selectively provided and disposed around or close to the light source 8 for suitably reflecting and/or concentrating and/or enhancing and/or reinforcing the light generated by the light source 8.

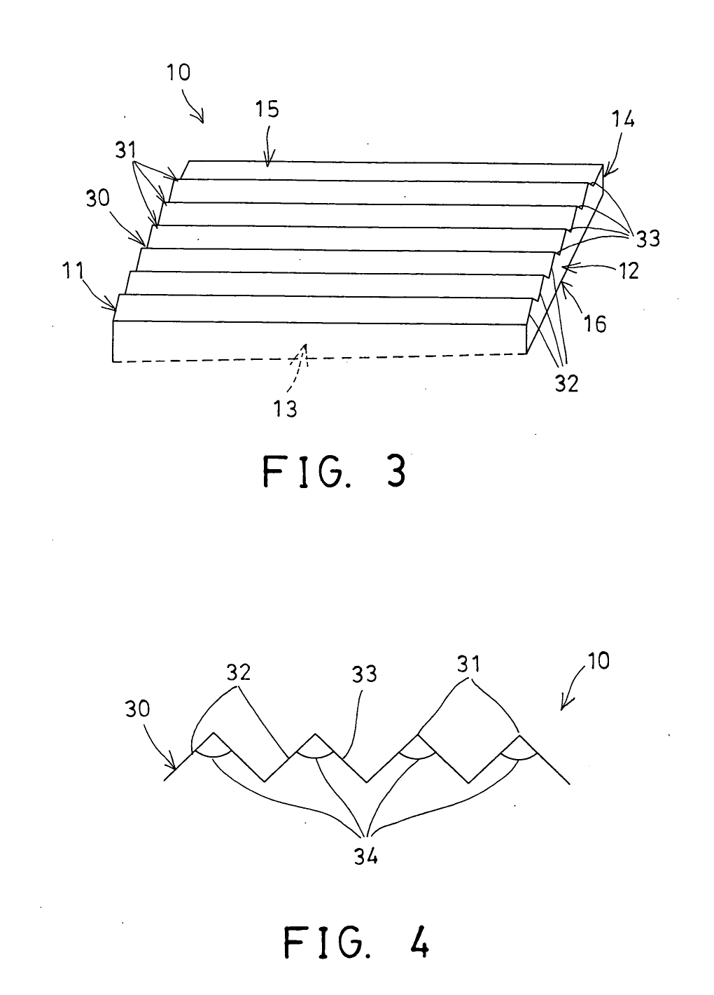

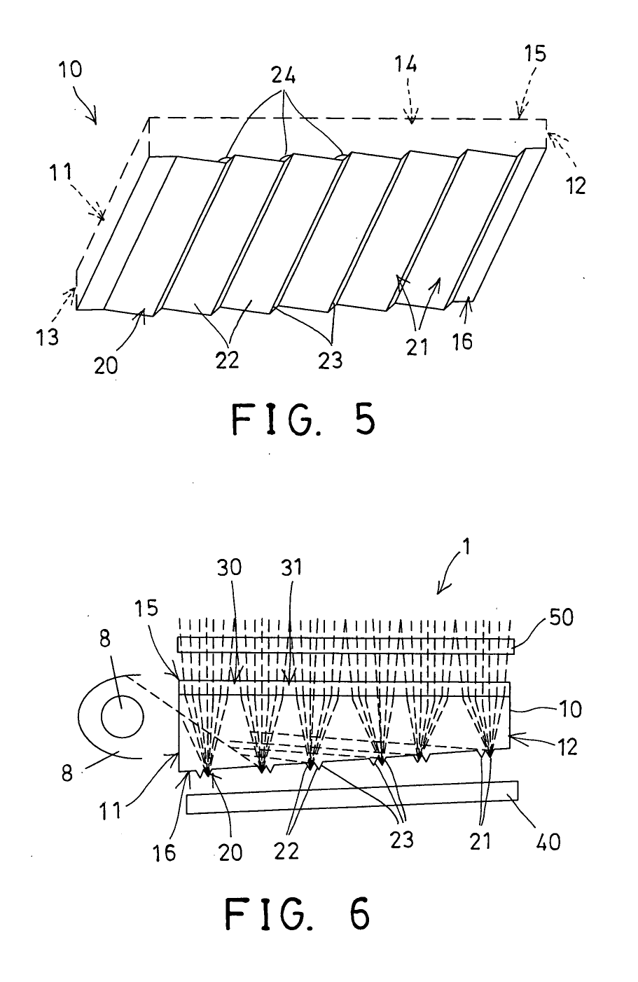

For example, as shown in FIGS. 2-5, the refracting member 10 includes a front portion 11 directed or facing toward or located close to the light source 8, a rear portion 12 directed or facing away from or distal to the light source 8 or on the opposite side of the front portion 11, two side portions 13, 14, an upper portion 15, and a bottom portion 16. The refracting member 10 further includes a first light refracting structure or device 20 formed or provided or located on the bottom portion 16 of the refracting member 10, and a second light refracting structure or device 30 formed or provided or located on the upper portion 15 of the refracting member 10.

As shown in FIGS. 1, 2 and 5, the first light refracting device 20 includes one or more bulges 21 extended from the bottom portion 16 of the refracting member 10 and each having two surfaces 22, 23 for forming or defining an included angle 24 between the surfaces 22, 23. It is preferable that the bulges 21 or the surfaces 22, 23 of the bulges 21 are arranged parallel to the front portion 11 or the rear portion 12 of the refracting member 10, or perpendicular to the side portions 13, 14 of the refracting member 10, or directed or faced toward the light source 8 for suitably refracting and/or reflecting and/or concentrating and/or enhancing and/or reinforcing the light generated by the light source 8 toward or through the upper portion 15 of the refracting member 10, best shown in FIG. 1.

The included angle 24 formed between the surfaces 22, 23 may be ranged from 60 to 110 degrees, and the bulges 21 that are located closer to the light source 8 may be spaced farther away from each other, and the bulges 21 that are located distal to the light source 8 may be spaced shorter from each other, or may be located closer to each other, or may have a distance smaller than that of the bulges 21 that are located closer to the light source 8 for uniformly refracting and/or reflecting the light generated by the light source 8. It is preferable that the surfaces 22 include a width greater than that of the other surfaces 23.

It is preferable that, as shown in FIG. 1, the surfaces 22 are arranged to have a smaller included angle relative to the light source 8 or to have an extended plane 25 located closer to the light source 8, and the other surfaces 23 are arranged to have a greater included angle relative to the light source 8 or to have an extended plane 26 located farther away from the light source 8, or are facing toward the light source 8 for suitably refracting and/or reflecting the light generated by the light source 8, and it is preferable that the front portion 11 of the refracting member 10 includes a thickness greater than that of the rear portion 12 of the refracting member 10, also best shown in FIG. 1, also for uniformly refracting and/or reflecting the light generated by the light source 8.

The second light refracting structure or device 30 includes one or more swellings 31 (FIGS. 2-4) the upper portion 15 of the refracting member 10, and each also having two surfaces 32, 33 for forming or defining an included angle 34 between the surfaces 32, 33. It is preferable that the swellings 31 or the surfaces 32, 33 of the swellings 31 are arranged parallel to the side portions 13, 14 of the refracting member 10 or perpendicular to the front portion 11 or the rear portion 12 of the refracting member 10, or perpendicular to the bulges 21, or directed or arranged parallel to the light source 8, for suitably refracting and/or reflecting and/or concentrating and/or enhancing and/or reinforcing the light refracted and/or reflected by or from the bulges 21 of the first light refracting device 20 of the refracting member 10, best shown in FIG. 1.

In operation, as shown in FIG. 1, the light generated by the light source 8 may be arranged to emit toward or through the refracting member 10, and may be suitably refracted and/or concentrated and/or diffused and/or enhanced and/or reinforced by the first light refracting device 20, for refracting and/or reflecting the light toward other light refracting structure or device 30 formed or provided or located on the upper portion 15 of the refracting member 10 which may then be used to suitably and uniformly refract and/or reflect the light, for allowing a stronger light to be emitted out of the refracting member 10 even when the light source 8 generates a weaker light.

The included angle 34 formed between the surfaces 32, 33 may be ranged from 80 to 100 degrees (FIG. 4), and the swellings 31 may be equally spaced away from each other, for suitably or uniformly refracting and/or reflecting the light refracted and/or reflected from the bulges 21 of the first light refracting device 20. A reflective member 40 may further be provided and disposed below the refracting member 10 for further reflecting the light from the refracting member 10, and a diffusive member 50 may further be provided and disposed above the refracting member 10 for further uniformly diffusing the light from the refracting member 10.

The prior or typical illuminating assemblies or light devices failed to provide a light refracting structure or device 20 formed or provided or located on the bottom portion 16 of the refracting member 10 for refracting and/or reflecting the light, and another light refracting structure or device 30 formed or provided or located on the upper portion 15 of the refracting member 10 for further refracting the light refracted and/or reflected from the bulges 21 of the first light refracting device 20.

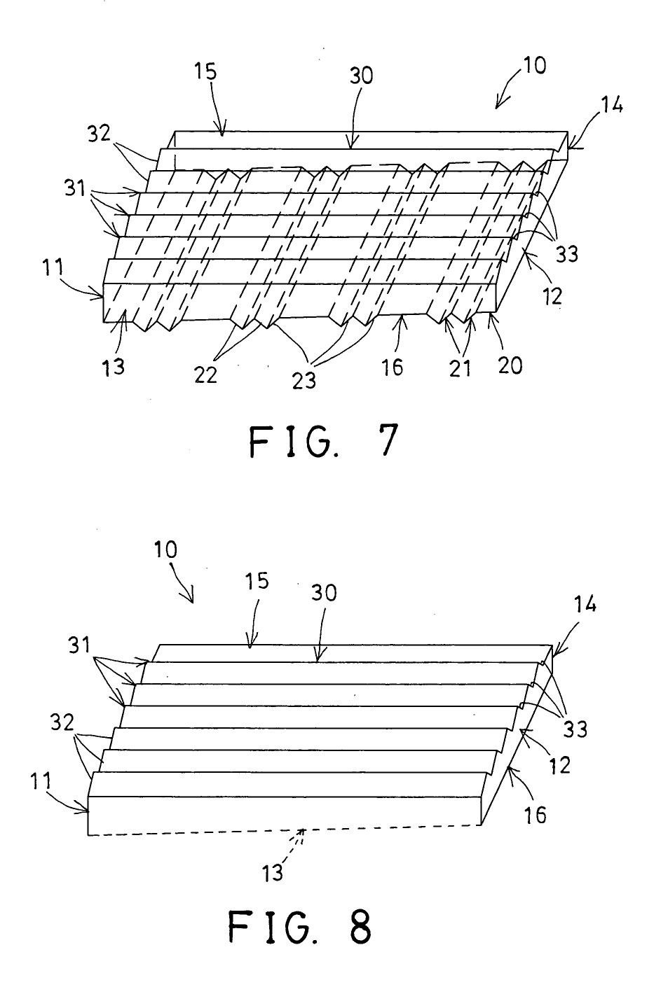

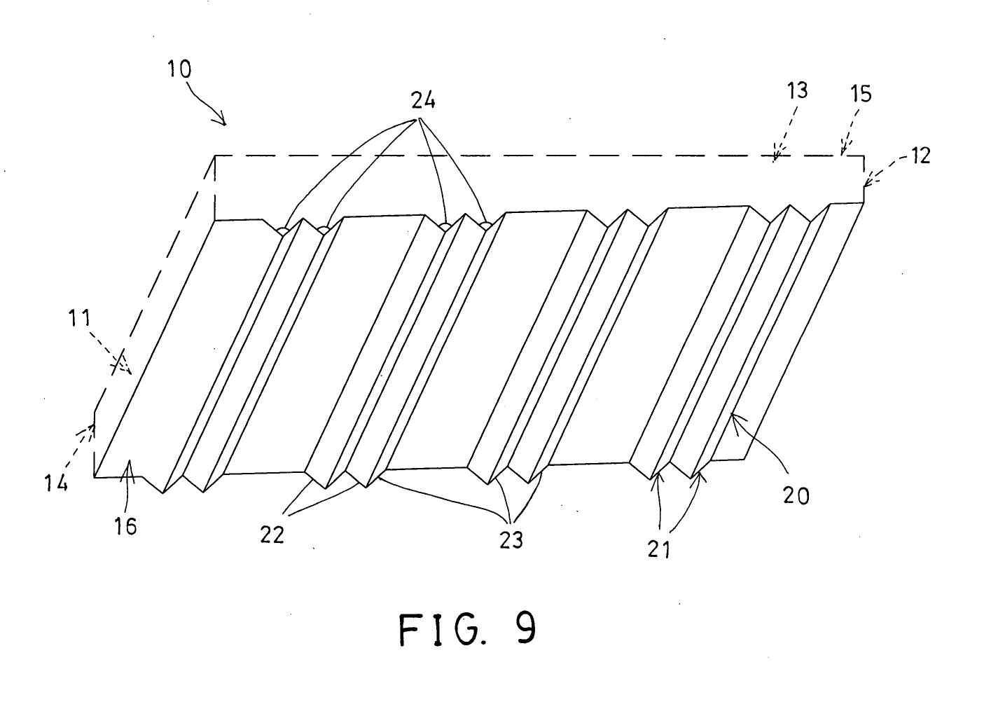

Alternatively, as shown in FIGS. 6-9, the bulges 21 of the first light refracting device 20 may be arranged or disposed in a way or arrangement different from that shown in FIGS. 1, 2 and 5. For example, the bulges 21 of the first light refracting device 20 may be arranged or disposed in pairs, and the pairs of the bulges 21 are suitably spaced away from each other for predetermined distances, and are arranged for suitably or uniformly refracting and/or reflecting the light generated by the light source 8.

Accordingly, the illuminating assembly in accordance with the present invention includes a refracting member for suitably refracting and/or concentrating and/or diffusing and/or enhancing and/or reinforcing the light generated by a light source of the illuminating assembly.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An illuminating assembly comprising:
a light source, and
a refracting member disposed beside said light source for refracting a light generated by said light source,
said refracting member including a bottom portion having a first light refracting device provided on said bottom portion of said refracting member for refracting the light generated by said light source, and including an upper portion having a second light refracting device provided on said upper portion of said refracting member for refracting the light from said first light refracting device.

2. The illuminating assembly as claimed in claim 1, wherein said first light refracting device includes at least one bulge extended from said bottom portion of said refracting member for refracting the light generated by said light source.

3. The illuminating assembly as claimed in claim 2, wherein said refracting member includes a front portion facing toward said light source, said at least one bulge includes two surfaces for forming an included angle between said surfaces, said at least one bulge and said surfaces of said at least one bulge are arranged parallel to said front portion of said refracting member.

4. The illuminating assembly as claimed in claim 3, wherein a first surface of said surfaces of said at least one bulge includes an extended plane located closer to said light source, and a second surface of said surfaces of said at least one bulge includes an extended plane located farther away from said light source.

5. The illuminating assembly as claimed in claim 4, wherein said first surface of said at least one bulge includes a width greater than that of said second surface of said at least one bulge.

6. The illuminating assembly as claimed in claim 3, wherein said refracting member includes a rear portion located distal to said light source, said front portion of said refracting member includes a thickness greater than that of said rear portion of said refracting member.

7. The illuminating assembly as claimed in claim 2, wherein said second light refracting device includes at least one swelling extended from said upper portion of said refracting member for refracting the light from said at least one bulge of said first light refracting device.

8. The illuminating assembly as claimed in claim 7, wherein said at least one swelling of said second light refracting device is perpendicular to said at least one bulge of said first light refracting device.

9. The illuminating assembly as claimed in claim 2, wherein said first light refracting device includes a second bulge extended from said bottom portion of said refracting member for refracting the light generated by said light source.

10. The illuminating assembly as claimed in claim 9, wherein said at least one bulge is located closer to said light source, and said second bulge is located farther away from said light source.

11. The illuminating assembly as claimed in claim 1, wherein said second light refracting device includes at least one swelling extended from said upper portion of said refracting member for refracting the light from said at least one bulge of said first light refracting device.

12. The illuminating assembly as claimed in claim 11, wherein said at least one swelling of said second light refracting device includes two surfaces for forming an included angle between said surfaces.

13. The illuminating assembly as claimed in claim 11, wherein said first light refracting device includes at least one bulge extended from said bottom portion of said refracting member, said at least one swelling of said second light refracting device is perpendicular to said at least one bulge of said first light refracting device.

14. The illuminating assembly as claimed in claim 1 further comprising a reflector disposed close to said light source for reflecting the light generated by said light source.

15. The illuminating assembly as claimed in claim 1 further comprising a reflective member disposed below said refracting member for reflecting the light from said refracting member.

16. The illuminating assembly as claimed in claim 1 further comprising a diffusive member disposed above said refracting member for diffusing the light from said refracting member.
